(19) United States
(12) Patent Application Publication
(10) Pub. No.: US 2012/0075082 A1
(43) Pub. Date: Mar. 29, 2012

(54) SYSTEM FOR LEARNING CONTROL CODES OF A REMOTE CONTROLLER

(75) Inventors: Fletcher Rothkopf, Los Altos, CA (US); Stephen Brian Lynch, Portola Valley, CA (US); Adam Mittleman, San Francisco, CA (US); Phil Hobson, Menlo Park, CA (US)

(73) Assignee: Apple Inc., Cupertino, CA (US)

(21) Appl. No.: 12/890,034

(22) Filed: Sep. 24, 2010

(51) Int. Cl. G08C 19/16; H04N 5/33; H04B 10/02

(52) U.S. Cl. 340/12.28; 398/106; 348/164; 348/E05.09

(57) ABSTRACT

One embodiment of an electronic device configured for supplying control codes to a programmable device may include a first receiver configured to receive a first command signal from a remote control device, a processing device coupled to the first receiver, and a transmitter configured to transmit a second command signal to a programmable device. The transmitter may be coupled to the processing device. The electronic device may further include a storage device coupled to the processing device. The storage device may be configured to store one or more control codes associated with the first command signal. The processing device may be configured to determine if the one or more control codes associated with the first command signal are stored on the storage device, and to transmit the second command signal to the programmable device via the transmitter if the processing device determines that the one or more control codes are stored on the storage device.

### BACKGROUND

I. Technical Field

Embodiments described herein relate generally to remote control devices, and more particularly, to systems for learning the control codes of remote control devices.

II. Background Discussion

Universal remote control devices can be programmed to emit command signals for controlling multiple controlled devices. To control the controlled devices, the universal remote controls may receive the control codes of a corresponding remote control device. The control codes may be embedded in the command signal emitted by the remote control device to control various controlled devices. Typically, the control codes may be input manually by a user. This may require the user to have to look up the device (e.g., using manufacturer or model information) in a table of control codes, or try each code listed in the table until one works, which can be inefficient and time-consuming. Other universal remote controls may allow the user to download the control codes from a remote server. However, downloading the codes from the server may require an Internet connection and take a prolonged period of time.

What is needed is a way to program a programmable electronic device so that the device can “learn” a few control codes corresponding to selected commands, while having the ability to receive other control codes from a remote database on an as-needed basis.

### SUMMARY

Embodiments described herein are directed to remote control devices and methods for learning the command signals of a remote control device and teaching the command signals to a programmable electronic device. The programmable electronic device may learn the control codes of a remote control device that is configured to control one or more electronic devices. Some embodiments may include an infrared-sensitive camera that is configured to receive command signals from a remote control device.

One embodiment may take the form of an electronic device configured for supplying control codes to a programmable device. The electronic device may include a first receiver configured to receive a first command signal from a remote control device, a processing device coupled to the first receiver, and a transmitter configured to transmit a second command signal to a programmable device. The transmitter may be coupled to the processing device. The electronic device may further include a storage device coupled to the processing device. The storage device may be configured to store one or more control codes associated with the first command signal. The processing device may be configured to determine if the one or more control codes associated with the first command signal are stored on the storage device, and to transmit the second command signal to the programmable device via the transmitter if the processing device determines that the one or more control codes are stored on the storage device.

Another embodiment may take the form of a method for operating a programmable device configured for learning one or more control codes of a remote control device. The method may include receiving an infrared command signal from the remote control device, capturing infrared data from the infrared command signal using a camera, and processing the captured infrared command signal to derive identifying information regarding the remote control device.

Another embodiment may take the form of a camera for capturing an infrared component of an infrared command signal. The camera may include an image sensor configured to sense an infrared command signal and a processing device coupled to the image sensor. The processing device may be configured to process the captured infrared command signal to derive identifying information regarding the remote control device.

### BRIEF DESCRIPTION OF THE DRAWINGS

FIG. 1 illustrates a schematic of one embodiment of a remote control learning system.

FIG. 2 illustrates a schematic of another embodiment of a remote control learning system.

FIG. 3 illustrates one embodiment of a camera that may be used in conjunction with the system illustrated in FIG. 2

FIG. 4 illustrates one embodiment of a method for learning the control codes of a remote control device and supplying the control codes to a programmable device.

FIG. 5 illustrates one embodiment of a method 600 for learning the control codes of a remote control device using a camera.

### DETAILED DESCRIPTION

The embodiments described herein are directed to remote control devices and methods for learning the command signals of a remote control device and teaching the command signals to a programmable electronic device. As discussed below, the programmable electronic device may learn the control codes of a remote control device that is configured to control one or more electronic devices. The electronic devices may include, but are not limited to, an audio-video (AV) device, such as a television, an AV receiver, a CD, DVD, or Blu-Ray player, and the like. In one embodiment, the programmable device may learn some of the control codes through a intermediary electronic device. The intermediary device may receive the control codes from the remote control device, or download the control codes from a remote server. The intermediary device may be communicatively coupled to the programmable device to “teach” the device the control codes.

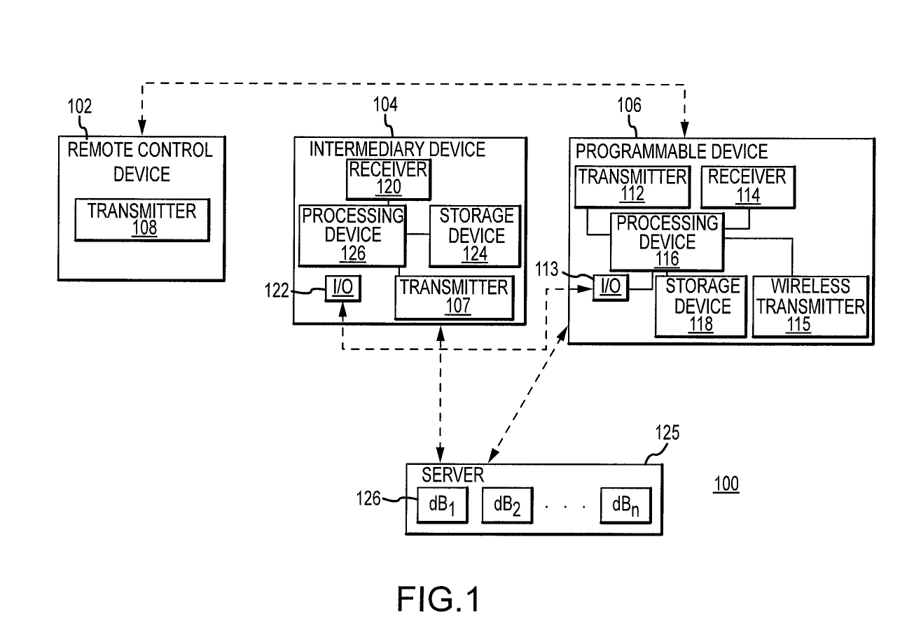

FIG. 1 illustrates a schematic of an embodiment of a remote control learning system. The system 100 may comprise a remote control device 102, an intermediary device 104, and a programmable electronic device 106. The remote control device 102 may include a transmitter 108 configured to transmit command signals to one or more controlled devices. The controlled devices may be any type of controllable electronic device. For example, the controlled device may be a consumer electronic device such as a personal computer, telephone, digital media player, set-top box, television, light dimmer, and so on and so forth. In one embodiment, the command signals transmitted by the transmitter 108 may be infrared (IR) signals. However, in other embodiments, the command signals may be other types of electromagnetic signals. For example, the command signals may be radio-frequency signals, microwaves signals, radio signals, and so on and so forth.

In one embodiment, the command signals may be a digital signal that includes a control code having a predetermined number of bits. The control codes may, in some cases, vary according to the manufacturer of the remote control device. For example, the RC-5 protocol, as developed by Koninklijke Philips Electronics N.V., uses a command signal that has a 14-bit pattern for each button pressed on a remote control device. The bit pattern can be decoded and analyzed to determine the manufacturer of the remote control and/or the model of the device being controlled.

The programmable electronic device 106 may include a transmitter 112 and an optional receiver 114 coupled to a processing device 116. The processing device 116 may be any type of commercially available processing device, including a central processing unit (CPU) or a microprocessor. In one embodiment, the transmitter 112 may be configured to transmit command signals to the one or more controlled devices that are also controllable by the remote control device 102. Where the programmable device 106 includes a receiver 114, the receiver 114 may be configured to receive command signals transmitted by the remote control device 102. For example, in one embodiment, the receiver 114 may be an IR receiver. Other embodiments may not include a receiver that is configured to receive command signals from the remote control device. A storage device 118 may also be coupled to the microprocessor 116. In one embodiment, the storage device 118 may be a memory device, such as non-volatile or volatile memory, a hard disk drive, a flash memory drive, and so on and so forth.

The storage device 118 may store software or firmware for running the programmable device 106. For example, in one embodiment, the storage device 118 may store system software that includes a set of instructions that are executable on the processing device 116 to enable the setup, operation and control of the programmable device 106. The software may also provide a menu-based operating system that can be navigated by the user through a graphical user interface displayed or presented to the user on a display screen. The user may navigate the graphical user interface to set up, operate and control the programmable device 106. In some embodiments, the storage device may further be configured to store a code table containing one or more control codes of the remote control device 102 for controlling one or more controllable devices. As will be further described below, the control codes may be downloaded from a remote storage device, or may be individually input by the user using the remote control device 102.

In one embodiment, the programmable device 106 may be a wireless communication device. In such case, the programmable device would include a wireless transmitter coupled to the processing device 116 for performing suitable wireless communication functions. The wireless communication device may include various fixed, mobile, and/or portable devices. Such devices may include, but are not limited to, cellular or mobile telephones, two-way radios, personal digital assistants, digital music players, Global Position System units, wireless keyboards, computer mice, and/or headsets, set-top boxes, and so on and so forth. In other embodiments, the programmable device 106 may take the form of some other type of electronic device capable of wireless communication. The programmable device 106 may also include an I/O port for establishing a wired connection a computing device or network. For example, the programmable electronic device 106 may be a laptop computer or a desktop computer capable of connecting to the Internet.

The intermediary device 104 may include a receiver 120 and an input-output (I/O) port 122 coupled to a processing device 126, which can be a microprocessor. The I/O port 122 may be configured to receive both input and output signals. For example, the I/O port may be a USB port. In other embodiments, the intermediary device may include separate input and output ports. The receiver 120 may be configured to receive command signals transmitted by the remote control device 102. In one embodiment, the intermediary device 104 may be coupled to the programmable device 106 via the I/O port 122. For example, the intermediary device 104 may be coupled to the programmable device 106 via a wire or other electrical conductor. In an alternative embodiment, the intermediary device 104 may include an optional transmitter 107 for wirelessly transmitting signals to the receiver 114 of the programmable device 106. For example, the intermediary device 104 may be communicatively coupled to the programmable device 106 via a Bluetooth connection or some type of wireless network.

The intermediary device 104 may further include a storage device 124 that may also be coupled to the microprocessor 126. In one embodiment, the storage device 124 may be a memory device, such as non-volatile or volatile memory, a hard disk drive, a flash memory drive, and so on and so forth. The storage device 124 may store software or firmware, along with one or more code tables containing the control codes for controlling one or more controllable devices. In one embodiment, the software may be system software that includes a set of instructions that are executable on the microprocessor 126 to enable the setup, operation and control of intermediary device 104. For example, the software may provide a menu-based operating system that can be navigated by the user through a graphical user interface displayed or presented to the user on a display screen. The user may navigate the graphical user interface to set up, operate and/or control the device 104.

The storage device 124 may further be configured to store a code table containing one or more control codes of the remote control device. The control codes may be broadcast in the command signals for controlling one or more controllable devices. As alluded to above, the control codes may be downloaded from a remote storage device, or may be individually input by the user using the remote control device.

In one embodiment, the intermediary device 104 may be a computing device. For example, the intermediary device may be a laptop, a desktop computer, a handheld personal computer, and so on and so forth. In another embodiment, the intermediary device may be some other type of electronic device. For example, the intermediary device may be a wireless communication device or a media player.

In one embodiment, the software may allow the intermediary device 104 to “learn” one or more of the control codes of the remote control device 102 and store the codes in the storage device 126. For example, the graphical user interface of the software may prompt the user to press a button on the remote control device to transmit a corresponding command signal. The control code corresponding to the signal may be captured by the receiver 114 and saved on the storage device 126 of the intermediary device 104.

In another embodiment, the intermediary device 104 may download the control codes from a remote server storing the control codes corresponding to multiple remote control devices. In this embodiment, the intermediary device 104 may be configured to derive identifying information regarding the remote control device 102 from a received command signal and use the identifying information to retrieve the control codes from the server. More particularly, the intermediary device 104 may process a received command signal transmitted by a remote control device 102 to derive the model and/or manufacturer information for the remote control device 102. The intermediary device 104 may then connect to a remote server 125 that includes one or more server databases 126 to store the control codes for various remote control devices. Using the manufacturer and/or model information, the intermediary device 104 may search the database 126 for records related to the remote control device (and its corresponding control codes). Once a match is found, the intermediary device 104 may download the control codes and save the codes on the storage device 124.

The software may also allow the intermediary device 104 to “teach” the control codes of the remote control device 102 to the programmable electronic device 106. More particularly, the intermediary device 104 may transmit the learned or downloadable command signals to the programmable electronic device 106, and the programmable electronic device 106 may store all or some of the control codes corresponding to the command signals on the storage device 118. After downloading the control codes, the programmable device 106 may use the control codes to transmit command signals via transmitter 112 to control the controlled devices corresponding to the codes.

In some cases, a user may only download some, as opposed to all, of the control codes of the remote control device 102 from the intermediary device 104 to the programmable electronic device 106. In such situations, the programmable electronic device 106 may download additional control codes from a remote database or server 125. In one embodiment, the software on the programmable electronic device 106 may be configured to determine model and/or manufacturer information for the controlled devices and transmit this information to the remote database or server 125. The remote server may then use the model and manufacturer information to obtain any additional control codes and transmit the codes to the programmable device 106. Accordingly, the user may initially learn only a few control codes from the intermediary device 104 and supplement these codes with additional codes from a remote server at a later time. This may be useful, for example, in situations in which it may be difficult or impossible for the intermediary device 104 to connect to the server, or if the user does not have enough time to download all of the control codes at once.

In other embodiments, the programmable device 106 may be connected to the remote server 125 and download the control codes directly from the server via a suitable I/O port 113 or a wireless transmitter 115, as opposed to the intermediary device 104. Accordingly, the user may learn some control codes from the intermediary device 104, and download others from the remote server.

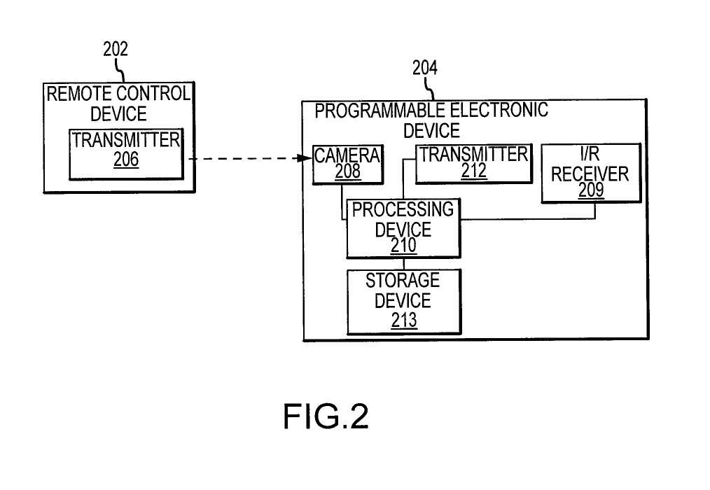

FIG. 2 illustrates a schematic of another embodiment of a remote control learning system. As shown in FIG. 2, the embodiment may include a remote control device 202 and a programmable electronic device 204. The remote control device 202 may include a transmitter 206, such as an IR transmitter, that is configured to transmit command signals to control one or more controlled devices. The programmable electronic device 204 may include a camera 208, and/or an I/R receiver 209 and a transmitter 212 that are each coupled to a processing device 210. In one embodiment, the processing device 210 may be a microprocessor. However, other embodiments may utilize other types of processing devices. Additionally, the programmable electronic device 204 may include a storage device 213 coupled to the processing device.

The storage device 213 may store software or firmware for running the programmable device 204. In one embodiment, the software may be system software that includes a set of instructions that are executable on the processing device 210 to enable the setup, operation and control of programmable device 204. The storage device 213 may further be configured to store one or more control codes of the remote control device 202 for controlling various controllable devices

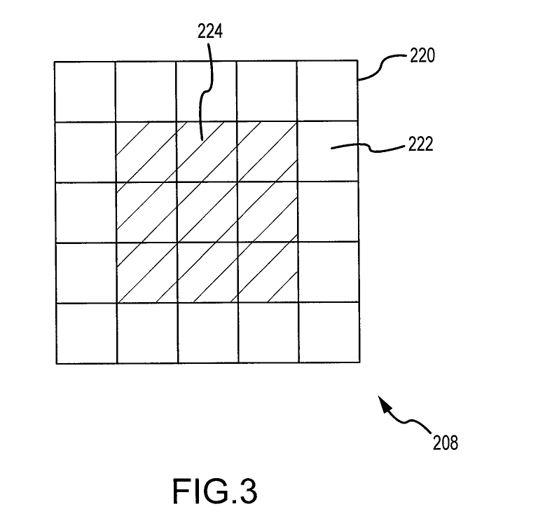

In one embodiment, the camera 208 of the programmable device 204 may function as an IR receiver. One embodiment of a camera 208 that may be used in conjunction with the system illustrated in FIG. 2 is shown in FIG. 3. As shown in FIG. 3, the camera 208 may be configured to capture still images, or may be a video camera. In either case, the camera 208 may include an image sensor 220 configured to sense infrared radiation. The image sensor 220 may be any type of commercially available image sensor, such as a charge-coupled device (CCD) or a complementary metal-oxide-semiconductor (CMOS) sensor. The image sensor may include a grid of light-sensitive pixels 222 configured to capture various wavelengths, including radiation in the infrared spectrum. Because infrared radiation absorbed by the pixels may diminish the quality of the produced images, an infrared filter 224 may be positioned over all or some of the pixels 222 of the image sensor 224 to block all or some of the incoming infrared light.

Where the infrared light is not completely blocked by a filter, the pixels of the image sensor may absorb incoming infrared light to produce an infrared image. Accordingly, the infrared image may be used to distinguish between different command signals transmitted by the electronic device. In one embodiment, the software may prompt the user to depress a button on the remote control device to emit a command signal. The software may also prompt the camera to capture the infrared command signal, and to process the corresponding image or video to obtain the control code corresponding to the pressed key. Alternatively, the separate I/R receiver may be used to receive transmitted I/R signals. The programmable device 204 may then use the control code to issue command signals to control a corresponding controlled device.

As discussed above, the IR command signals from the remote control device 202 may be a series of bits organized according to a unique bit pattern. In one embodiment, the camera may capture the pattern by capturing multiple rapid still images of the emitted pattern at different times and processing the images to derive the bit pattern. In other embodiments, the camera may capture a single image of the command signal. For example, the exposure time of the camera may be prolonged so as to capture a single still image representing the IR command signal. In a further embodiment, the camera 208 may be a video camera configured to capture the command signal. The captured video may then be processed by the camera to derive the bit pattern of the command signal.

As shown in FIG. 3, in one embodiment, the camera 208 may include an infrared filter 224 that is positioned over some, but not all of the pixels of the image sensor. More particularly, the infrared filter 224 may be positioned over the central pixels of the image sensor 220, leaving the edge pixels uncovered. In this embodiment, the edge pixels may capture an infrared image, while the infrared filter may block all or some of the infrared signal from being absorbed by the central pixels. To form a conventional digital image, all of the pixels 222 in the grid may be exposed to light, but the camera may crop the edge pixels to form the final image or video. In contrast, the camera may process the edge pixels to capture the IR command signals emitted by the remote control device 202.

Other embodiments may utilize infrared filters having different configurations. For example, one embodiment may include an infrared filter that covers the top or bottom half of the grid, or one side of the grid. Another embodiment may utilize a triangular, circular, or other shape of filter.

Another embodiment may utilize a shutter mechanism for controlling the amount of infrared light impacting on the pixels of the image sensor. In one embodiment, the shutter may be configured as an infrared filter. When closed, the shutter may be positioned in front of the grid to block infrared light from diminishing the quality of the produced image. Accordingly, the shutter may be closed when taking a conventional image, and left open when taking an infrared image of the remote command signal.

Similarly, in another embodiment, the shutter may be an unfiltered infrared sensor that may be selectively closed to cover an image sensor including an infrared filter. Accordingly, the shutter may be closed to capture the infrared image and opened to capture a conventional image.

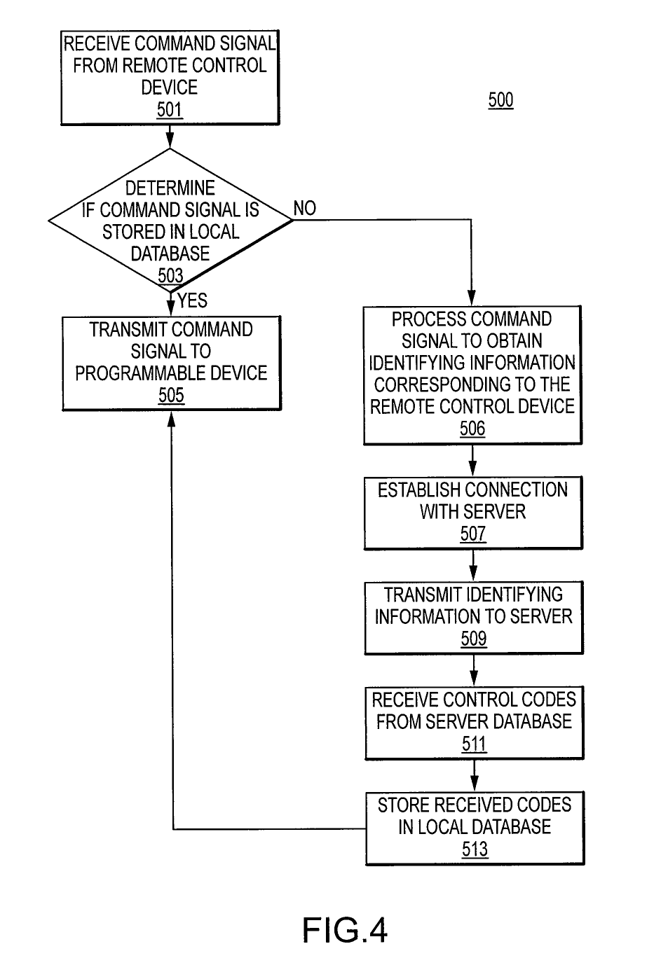

FIG. 4 illustrates one embodiment of a method 500 for learning the control codes of a remote control device and supplying the control codes to a programmable device. In one embodiment, one or more of the operations of the method 500 may be executed on a device similar to the intermediary device 104 shown and described in FIG. 1. In the operation of block 501, the intermediary device 104 may receive a command signal from a remote control device. As discussed above, the command signal may be an IR signal including a control command for controlling a particular controllable device. The control command may include a unique bit pattern that can be processed to determine manufacturer and/or model information regarding the controllable device. In the operation of block 503, the intermediary device 104 may determine if the control code of received command signal is stored in a database of control codes. In one embodiment, the database may be resident on the storage device of the intermediary device 104. However, in other embodiments, the database may be stored on a storage device external to the intermediary device 104.

If, in the operation of block 503, the intermediary device 104 determines that the control code is stored in the database of the intermediary device 104, then, in the operation of block 503, the intermediary device 104 may transmit the control code to the programmable device, which may use the control code to control the corresponding controlled device.

If, however, the intermediary device 104 determines that the control code for the signal is not stored in the database of the intermediary device 104, then, in the operation of block 506, the intermediary device 104 may process the signal to obtain identifying information corresponding to the remote control device. For example, the identifying information may be manufacturer and/or model information for the remote control device. In the operation of block 507, the intermediary device 104 may establish a connection with a remote server. For example, the server 125 and the intermediary device 104 may be coupled by a wired or a wireless network. The server 125 may include a server database 126 that contains the control codes associated with one or more remote control devices 102. In the operation of block 509, the intermediary device 104 may transmit the identifying information to the server, which may use the identifying information to search for the control codes corresponding to the identified remote control device. In the operation of block 511, the intermediary device 104 may receive some or all of the control codes corresponding to the identified remote control device from the server 125. In the operation of block 513, the intermediary device 104 may store the received control codes in a database maintained on the storage device of the intermediary device 104. The method may then proceed to the operation of block 505, in which a command signal including the control codes may be transmitted to the programmable device 106.

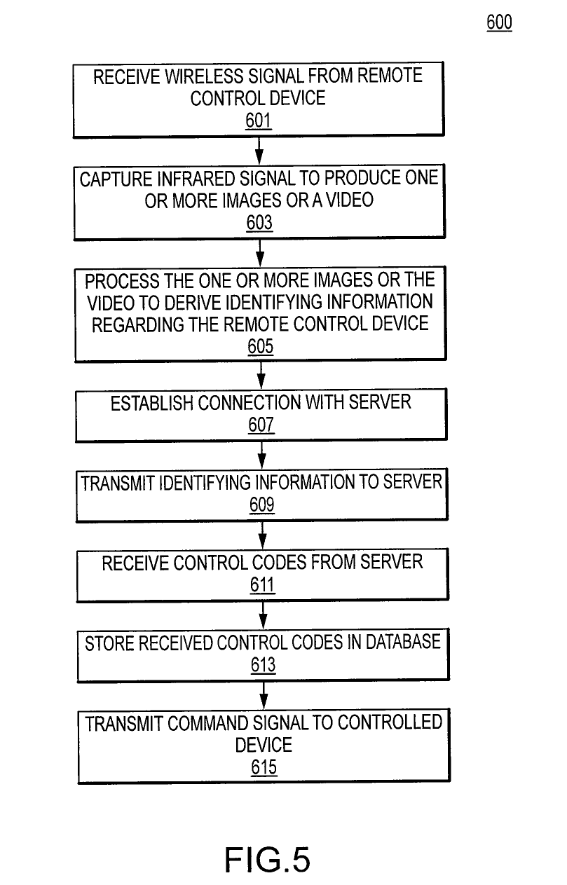

FIG. 5 illustrates one embodiment of a method 600 for learning the control codes of a remote control device using a camera. In one embodiment, one or more of the operations of the method 600 may be performed by a programmable electronic device that includes an infrared sensitive camera. In the operation of block 601, the camera may receive an IR command signal from the remote control device. As discussed above, the IR command signal may include a predefined number of bits transmitted in a particular bit pattern.

In the operation of block 603, the camera may capture the infrared command signal emitted by the remote control device to produce one or more images or a video. For example, the camera may be configured to capture multiple infrared images in rapid succession as the command signal is being transmitted, or to capture video of the infrared signal. The camera may then process the one or more images or the video to derive identifying information regarding the remote control device. This may be accomplished by analyzing the bit pattern of the command signal, which may be encoded with manufacturer and/or model information for the remote control device.

The operations of blocks 607, 609, 611, and 613 may be similar or identical to the operations of blocks 507, 509, 511, and 513 of the method shown in FIG. 4. In the operation of block 607, the programmable device 204 may establish a connection with a remote server 125. For example, the server 125 and the programmable device 204 may be coupled by a wireless network. The server may include a server database 126 that contains the control codes associated with one or more remote control devices. In the operation of block 609, the programmable device 204 may transmit the identifying information to the server, which may use the identifying information to search the server database 126 for the control codes corresponding to the identified remote control device. In the operation of block 611, the programmable device 204 may receive some or all of the control codes corresponding to the identified remote control device from the server. In the operation of block 613, the programmable device 204 may store the received control codes in a local database maintained on the storage device of the intermediary device 104. The method may then proceed to the operation of block 615, in which the programmable device 204 may transmit a command signal including the control codes to control a controlled device.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element are all possible sequences of execution.

1. An electronic device configured for supplying control codes to a programmable device, the electronic device comprising:
a first receiver configured to receive a first command signal from a remote control device;
a processing device coupled to the first receiver;
a transmitter configured to transmit a second command signal to a programmable device, the transmitter coupled to the processing device; and
a storage device coupled to the processing device, the storage device configured to store one or more control codes associated with the first command signal;
wherein the processing device is configured to determine if the one or more control codes associated with the first command signal are stored on the storage device, and to transmit the second command signal to the programmable device via the transmitter if the processing device determines that the one or more control codes are stored on the storage device.

2. The electronic device of claim 1, wherein the transmitter is configured to transmit the second command signal over a wired connection.

3. The electronic device of claim 1, wherein, if the processing device determines that the one or more control codes are not stored on the storage device, the processing device is configured to process the first command signal to obtain identifying information corresponding to the remote control device.

4. The electronic device of claim 2, wherein the identifying information comprises a manufacturer and a model of the remote control device.

5. The electronic device of claim 2, wherein the electronic device is a laptop.

6. The electronic device of claim 2, wherein the electronic device is further configured transmit the identifying information to a remote server.

7. The electronic device of claim 6, further comprising a second receiver configured to receive one or more control codes from the server.

8. The electronic device of claim 7, wherein the processing device is further configured to store the one or more control codes on the storage device.

9. The electronic device of claim 8, wherein the programmable device is a wireless communication device.

10. A method for operating a programmable device configured for learning one or more control codes of a remote control device, comprising:
receiving an infrared command signal from the remote control device;
capturing infrared data from the infrared command signal using a camera; and
processing the captured infrared command signal to derive identifying information regarding the remote control device.

11. The method of claim 10, further comprising:
establishing a connection with a server configured to process the identifying information to obtain a control code of the infrared command signal; and
transmitting the identifying information to the server.

12. The method of claim 11, wherein the identifying information comprises a manufacturer and a model of the remote control device.

13. The method of claim 11, further comprising receiving a control code from the server and storing the control code on a storage device.

14. The method of claim 13, further comprising transmitting a command signal comprising the control code to a controlled device.

15. A camera for capturing an infrared component of an infrared command signal, comprising:
an image sensor configured to sense an infrared command signal; and
a processing device coupled to the image sensor, the processing device configured to process the captured infrared command signal to derive identifying information regarding the remote control device.

16. The camera of claim 15, wherein the image sensor comprises a grid including one or more infrared-sensitive pixels; and
an infrared-blocking filter configured to at least partially block infrared radiation from at least one of the one or more pixels.

17. The camera of claim 16, wherein the grid includes a central portion comprising one or more central pixels and an edge portion comprising one or more edge pixels, the edge portion at least partially surrounds the central portion, and the infrared-blocking filter is configured to at least partially block infrared radiation from the one or more central pixels of the central portion.

18. The camera of claim 15, wherein the identifying information includes a manufacturer and a model of the remote control device.

19. The camera of claim 15, wherein the camera is a video camera.

20. The camera of claim 15, wherein the camera is configured to capture one or more still images.
